(19) United States
(12) Patent Application Publication
(10) Pub. No.: US 2012/0012447 A1
(43) Pub. Date: Jan. 19, 2012

(54) LIGHT SWITCH EXTENDER

(76) Inventor: Kathi SIMPSON, Blue Springs, MO (US)

(21) Appl. No.: 12/837,843

(22) Filed: Jul. 16, 2010

(51) Int. Cl. H01H 9/00

(52) U.S. Cl. 200/331

(57) ABSTRACT

A light switch extender for application on a light switch comprising: a plate, where said plate includes two elongated openings and switch opening; an extending arm, said arm extends vertically downward from the plate; and a handle at the distal end of the extending arm, where said handle enables the vertically movement of the arm. The plate is placed under a light switch plate to engage a light switch. In one particular embodiment, the handle includes an opening and the arm is at least one foot in length.

### BACKGROUND OF THE INVENTION

1. Field of Invention

The present invention relates to a light switch extender that is capable of providing a lower access to a light switch therefore making it accessible for use by toddlers and children.

2. Description of Related Art

A light switch is a common electrical device used in both residential and commercial buildings to operate electrical lights. The light switch is conveniently used and set at appropriate height for operation by most adults. The light switch is an on and off switch that usually has a toggle device within the switch to place the electrical connection in the on position and to disconnect the electrical connection in the off position. Usually the light switch operates in an up and a down motion although some variations of the light switch include a push button type, a rocker type switch, or even a push and pull cord. Furthermore some light switches may include a dimmer control in order to control the intensity of the light within the room.

The typical light switch is mounted at about 48 inches from the surface of the floor. The height of the switch may vary based on the various building codes in certain municipalities; however, the common height is about 48 inches. The light switch is of course easily operable by any adult at this particular height. A drawback to placement of the light switches at this particular height is that a toddler or small child cannot operate the light switch without having to step on a stool or other device in order to reach the light switch for operation. Since the light switch is placed in a position in accordance with building codes, it would be difficult for the user or a builder to lower the light switch specifically for operation by an infant. Consequently it would be advantageous to have a device that could easily attach to an existing light switch in order to provide an infant or toddler a means operate the light switch without the use a step stool or other height boosting device.

### SUMMARY OF THE INVENTION

The present invention relates to a light switch extender for application on a light switch comprising: a plate, where said plate includes two elongated openings and switch opening; an extending arm, said arm extends vertically downward from the plate; and a handle at the distal end of the extending arm, where said handle enables the vertically movement of the arm. The plate is placed under a light switch plate to engage a light switch. In one particular embodiment, the handle includes an opening and the arm is at least one foot in length.

### BRIEF DESCRIPTION OF DRAWINGS

FIG. 1A depicts an exemplary embodiment of the light switch extender according to the present invention.

FIG. 1B depicts the alternative embodiment of the light switch extender according to the present invention.

FIG. 2 depicts an exploded view the installation of a light switch extender according to the present invention.

### DETAILED DESCRIPTION

The present invention relates to a light switch extender that allows the operation of a light switch by an infant or toddler. The light switch extender extends or lowers a handle for use by a toddler that operates the on and off function of a light switch. The light switch extender according to present invention may be installed upon any conventional light switch in an existing residential or commercial building. The use of the light switch extender obviates the need for the lowering of a light switch which may be against building codes but provides an alternative means for operation of the light switch that is conducive for use by toddlers or children.

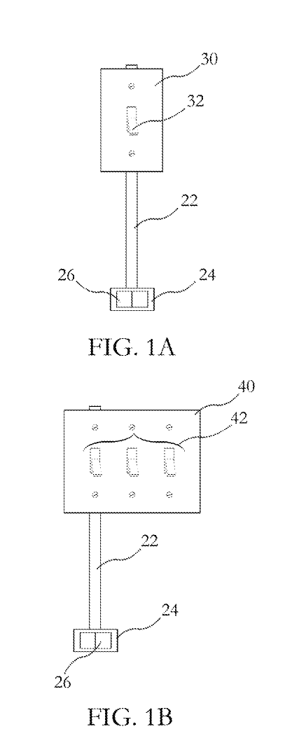

In reference to FIG. 1A, a light switch extender according to the present invention is depicted. The light switch extender includes a handle 24 at the bottom end of an extending arm 22, where the handle 24 also includes an opening 26. The extender attaches to a light switch 32 which is covered by a plate 30. The extender arm 22 moves vertically in conjunction with the movement of the light switch 32. A toddler or child may use the handle 24 to move the light switch 32 to an up position normally an on position and to move the extender arm downwardly to place the switch 32 in an off position. The vertical movement of the extender arm 22 therefore provides a means for the toddler or child to maneuver the light switch without the need of stepping onto a step stool or other device to enable the child to reach the light switch.

FIG. 1B depicts an alternative embodiment of the present invention. The light switch extender arm 22 is used in conjunction with at least one switch of the plurality of switches 42 depicted In FIG. 1B. A plate 40 covers the plurality of switches 42. The light switch extender in this particular embodiment enables the use of the extender upon one switch of the plurality of switches 42 provided under the plate 40. This particular embodiment helps to allow a toddler to operate at least one of the switches of the plurality of switches 42 under the plate 40.

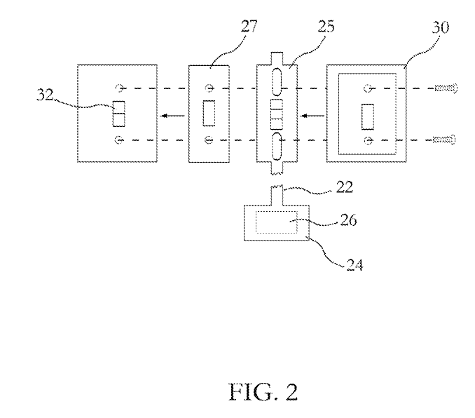

FIG. 2 provides an exploded view of the installation of a light switch extender according to the present invention. As noted the extender arm 22 extends downwardly from a plate 25. This plate 25 may be inserted over a switch cover 27 that covers the switch 32. The switch plate cover 30 is provided to cover the entire assembly over the switch 32. Screws are provided that extend through the plate 30, plate 25 and switch cover 27 for the placement of the entire assembly over the switch 32. Once these items are placed in position, a child or toddler may utilize the light switch extender. It is noted that the extender plate 25 includes two openings 23a, 23b that are elongated and provided for the vertical movement of the extender arm 22 by the toddler. The openings 23a, 23b are sufficient length for the movement of the light switch 32. As can be readily recognized, the plate 30 may be any conventional light switch plate that currently is in use, which may be removed for the insertion of the extender plate 25 and switch cover 27. Once these components are assembled the toddler or child may operate the extender arm 22.

The light switch extender according to the present invention provides an alternative method for the toddler or child to operate a light switch without the necessity of using a stool or scaling furniture in order to reach the light switch. The extender places the operation of the light switch in reach so that the toddler or child may maneuver the light switch to an on or off position easily. Further, the light switch extender is capable of installation upon any conventional light switch that is currently installed in any residence or commercial building. The instant invention has been shown and described in what it considers to be the most practical and preferred embodiments. It is recognized, however, that departures may be made there from within the scope of the invention and that obvious modifications will occur to a person skilled in the art.

What is claimed is:

1. A light switch extender for application on a light switch comprising:
a. a plate, where said plate includes two elongated openings and switch opening;
b. an extending arm, said arm extends vertically downward from the plate; and
c. a handle at the distal end of the extending arm, where said handle enables the vertically movement of the arm.

2. The light switch extender according to claim 1, where plate is placed under a light switch plate to engage a light switch.

3. The light switch extender according to claim 1, where said handle includes an opening.

4. The light switch extender according to claim 1, where said arm is at least one foot in length.
